(19) United States
(12) Patent Application Publication
(10) Pub. No.: US 2024/0152373 A1
(43) Pub. Date: May 9, 2024

(54) PROVIDING HARDWARE FEEDBACK INFORMATION IN A VIRTUAL ENVIRONMENT

(71) Applicant: Intel Corporation, Santa Clara, CA (US)

(72) Inventors: Raoul Rivas Toledano, Hillsboro, OR (US); Brandon Luk, Monte Sereno, CA (US); William Braun, Beaverton, OR (US)

(21) Appl. No.: 17/983,425

(22) Filed: Nov. 9, 2022

(51) Int. Cl. G06F 9/455

(52) U.S. Cl. CPC G06F 9/45558; G06F 2009/45583; G06F 2009/45591

(57) ABSTRACT

In one embodiment, a method includes: receiving, in a first circuit of a processor, an indication of an entry of the processor into a first virtual machine, the processor to execute in a virtual machine environment having a root partition and at least one virtual partition comprising the first virtual machine; allocating a first hardware feedback structure for the root partition and allocating a second hardware feedback structure for the at least one virtual partition; populating the first hardware feedback structure with first performance and efficiency information regarding a plurality of cores of the processor; populating the second hardware feedback structure with the first performance and efficiency information regarding the plurality of cores of the processor; and providing the first performance and efficiency information from the second hardware feedback structure to a virtual machine scheduler of the at least one virtual partition. Other embodiments are described and claimed.

### BACKGROUND

Many modern processors make use of a hybrid architecture in which there may reside two or more types of processor cores. The different core types may be heterogenous in terms of architecture, size, in-order/out-of-order capabilities, performance, and/or efficiency. Recent Intel Corporation processors provide two types of cores, efficient (E) cores and performance (P) cores. In full power scenarios, the P-cores offer the best performance, but in low power scenarios where voltage may be throttled, E-cores offer better performance.

Two technologies enable efficient use of this hybrid architecture. The first is a metric, Quality of Service (QoS) (handled by an operating system), that denotes the importance of any given thread. The second is Hardware Guided Scheduling (HGS), which allows the processor to provide hints to the operating system. These hints include the dynamic performance and energy efficiency capabilities of the P-cores and E-cores based on power/thermal limits and core parking and idling hints. With these two technologies, the operating system can make efficient use of the hybrid architecture by scheduling threads with important QoS on cores that are at that moment more performant and threads with unimportant QoS on cores that are at that moment less performant. However, such technologies are not optimized for virtual environments.

### BRIEF DESCRIPTION OF THE DRAWINGS

FIG. 1 is a block diagram of a computing system in accordance with an embodiment.

FIG. 2 is block diagram of a system on chip in accordance with an embodiment.

FIG. 3 is a block diagram illustrating a virtual environment in accordance with an embodiment.

FIG. 4 is a flow diagram of a method in accordance with an embodiment.

FIG. 5 is a flow diagram of a method in accordance with another embodiment.

FIG. 6 is a flow diagram of a method in accordance with yet another embodiment.

FIG. 7 illustrates an example computing system.

FIG. 8 illustrates a block diagram of an example processor and/or System on a Chip (SoC) that may have one or more cores and an integrated memory controller.

FIG. 9 is a block diagram illustrating both an example in-order architecture core and an example register renaming, out-of-order issue/execution architecture core to be included in a processor according to examples.

### DETAILED DESCRIPTION

In various embodiments, a processor is configured to provide hardware feedback information to multiple entities in a virtual environment. More specifically, the processor may communicate this hardware feedback information directly to a root partition and one or more virtual partitions. In this way, schedulers for both virtual machines (VMs) and root may use this information in scheduling threads to an appropriate core type.

In contrast, without an embodiment this hardware feedback information is provided for a native operating system (OS) only, and is not provided to a hypervisor that runs one or multiple VMs concurrently. In cases where the root partition is responsible for scheduling VMs through a hierarchical scheduler (e.g., where a VM or VM scheduler schedules threads to a set of virtual processors that are then given to the root partition to be scheduled along with the root's own threads), it is typical for the VM to assign QoS values to virtual processors that match QoS values of threads scheduled on those virtual processors.

Thus without an embodiment, when a root scheduler receives virtual processors, it can, to some degree, take into consideration the QoS levels of the threads of the virtual machine. However, the virtual machine does not have any hardware feedback information as to static or dynamic core capabilities. Accordingly without an embodiment, a VM views its virtual processors as a homogenous set, contrary to an actual underlying hybrid topology of a processor, and has no access to hardware feedback information such as performance/efficiency data and cannot efficiently use QoS information in its own scheduling algorithm. Thus without an embodiment when a VM schedules a set of threads with mixed QoS levels, threads with important or unimportant QoS will be scheduled on any given virtual processor, regardless of the underlying scheduling of virtual processors into physical cores.

In this scenario without an embodiment, a root scheduler possibly migrates and re-schedules virtual processors onto hybrid core types (e.g., efficient or performance physical cores) based on QoS information assigned to the virtual processors and a current state of hardware feedback information. This arrangement results in the root constantly migrating and reshuffling virtual processor-to-physical processor mappings, increasing complexity and impacting performance. Therefore, without an embodiment, there can be stretches of time in which virtual processors running higher priority QoS threads are assigned to physical processors that are less performant (according to hardware feedback information) and vice versa.

To overcome these concerns, hardware feedback information is provided to each VM. While different manners of communicating this information are possible, in one embodiment, a HGS feedback table may be allocated for each VM. In a particular embodiment, a HGS feedback table may be instantiated for each VM, along with another table instantiation for the root partition. In such embodiments, this table may include data provided by a hardware guided scheduling source such as an Intel® Thread Director implementation. Details of the information to be stored into such table are described further below.

In embodiments, during each entry into a virtual machine (e.g., on a VM switch), this HGS feedback table is populated to enable the virtual machine to utilize hardware feedback information (such as provided via Intel® Thread Director technology) to make better scheduling decisions on hybrid cores. With this hardware feedback information, virtual machines can schedule their threads with better respect for the physical topology and dynamic performance/efficiency ratios of the processor. This more appropriate initial scheduling of threads results in the root partition having to do less (or zero) reshuffling of virtual processor-to-physical processor mappings than conventional scheduling as described above, ultimately increasing system performance and power efficiency.

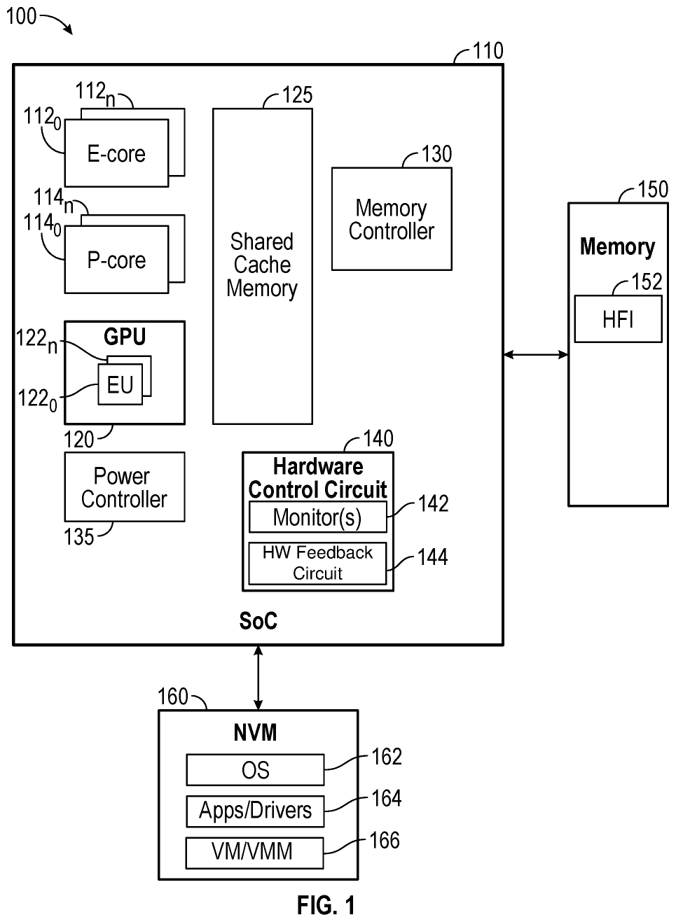

Referring now to FIG. 1, shown is a block diagram of a system in accordance with an embodiment. As shown in FIG. 1, computing system 100 may be any type of computing device, ranging from a relatively small device such as a smartphone to larger devices, including laptop computers, desktop computers, server computers or so forth. In the high level shown in FIG. 1, an SoC 110 couples to a memory 150 which is a system memory (e.g., a dynamic random access memory (DRAM)), and a non-volatile memory 160 which in different embodiments can be implemented as a flash memory, disk drive or so forth. Understand that the terms “system on chip” or “SoC” are to be broadly construed to mean an integrated circuit having one or more semiconductor dies implemented in a package, whether a single die, a plurality of dies on a common substrate, or a plurality of dies at least some of which are in stacked relation. Thus as used herein, such SoCs are contemplated to include separate chiplets, dielets, and/or tiles, and the terms “system in package” and “SiP” are interchangeable with system on chip and SoC.

With respect to SoC 110, included are a plurality of cores. In the particular embodiment shown, two different core types are present, namely first cores 112₀-112ₙ (so-called efficiency cores (E-cores)) and second cores 114₀₋ₙ (so-called performance cores (P-cores)). As further shown, SoC 110 includes a graphics processing unit (GPU) 120 including a plurality of execution units (EUs) 122₀₋ₙ. In one or more embodiments, first cores 112 and second cores 114 and/or GPU 120 may be implemented on separate dies.

These various computing elements couple to additional components of SoC 110, including a shared cache memory 125, which in an embodiment may be a last level cache (LLC) having a distributed architecture. In addition, a memory controller 130 is present along with a power controller 135, which may be implemented as a hardware control circuit that may be a dedicated microcontroller to execute instructions, e.g., stored on a non-transitory storage medium (e.g., firmware instructions). In other cases, power controller 135 may have different portions that are distributed across one or more of the available cores.

Still with reference to FIG. 1, SoC 110 further includes a hardware control circuit 140 independent of power controller 135. In various embodiments herein, hardware control circuit 140 may be configured to monitor operating conditions, e.g., using one or more monitors 142. Based at least in part on the monitored operating conditions, a hardware feedback circuit 144 of hardware control circuit 140 may maintain hardware feedback information, which may dynamically indicate processor capabilities, e.g., with respect to performance and efficiency. In one embodiment, hardware feedback circuit 144 may update information present in an interface structure stored in memory 150. Specifically, a hardware feedback interface (HFI) 152 may be stored in memory 150 that includes information regarding, inter alia, efficiency and performance levels of various cores. As described further herein, this hardware feedback information may be maintained in multiple forms, including a first instantiation for use by a root partition and one or more second instantiations for use by one or more virtual environments.

When this information is updated, hardware control circuit 140 may communicate, e.g., via an interrupt, to OS 162. As illustrated, NVM 160 may store an OS 162, various applications, drivers and other software (generally identified at 164), and one or more virtualization environments 166 (generally identified as VMM/VM 166). In one instantiation, communication of hardware feedback information to OS 162 and VMM/VMs 166 may be via Intel® Thread Director technology, implemented at least in part in hardware feedback circuit 144.

Understand while shown at this high level in the embodiment of FIG. 1, many variations and alternatives are possible, and other implementations of SoC 100 can equally incorporate embodiments. For example depending on market segment, an SoC can include, instead of a hybrid product having heterogeneous core types, only cores of a single type. Further, more or different accelerator types may be present. For example, in addition to or instead of GPUs, an SoC may include a direct streaming accelerator (DSA), field programmable gate array (FPGA) or other accelerator.

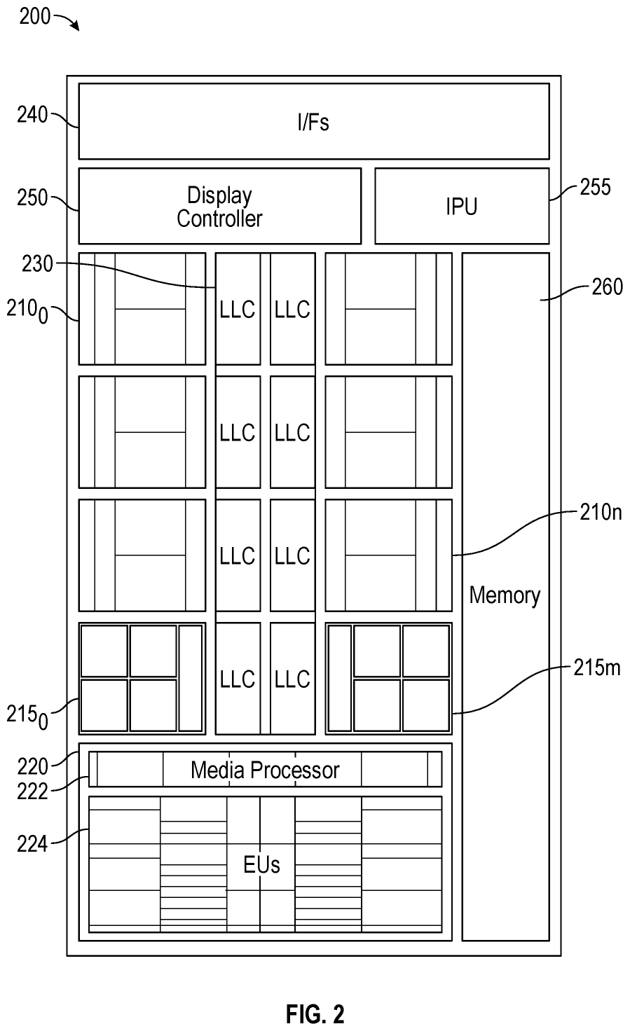

Referring now to FIG. 2, shown is a block diagram of an SoC in accordance with another embodiment. More specifically as shown in FIG. 2, SoC 200 is a multicore processor, including a first plurality of cores 210₀₋ₙ and a second plurality of cores 215₀₋ₘ. In one or more embodiments, first cores 210 may be implemented as performance cores, in that they may include greater amounts of circuitry (and wider and deeper pipelines) to perform more advanced computations in a performant manner. In contrast, second cores 215 may be configured as smaller cores that consume less power and may perform computations in a more efficient manner (e.g., with respect to power) than first cores 210. In certain implementations, first cores 210 may be referred to as P-cores (for performance cores) and second cores 215 may be referred to as E-cores (for efficiency cores). Note that different numbers of first and second cores may be present in different implementations.

As further illustrated in FIG. 2, a cache memory 230 may be implemented as a shared cache arranged in a distributed manner. In one or more embodiments, cache memory 230 may be a LLC having a distributed implementation in which one or more banks are associated with each of the cores.

As further illustrated, a GPU 220 may include a media processor 222 and a plurality of EUs 224. Graphics processor 220 may be configured for efficiently performing graphics or other operations that can be broken apart for execution on parallel processing units such as EUs 224.

Still referring to FIG. 2, various interface circuitry 240 is present to enable interface to other components of a system. Although embodiments are not limited in this regard, such interface circuitry may include a Peripheral Component Interconnect Express (PCIe) interface, one or more Thunderbolt™ interfaces, an Intel® Gaussian and Neural Accelerator (GNA) coprocessor and so forth. As further illustrated, processor 200 includes a display controller 250 and an image processing unit (IPU) 255.

As further shown, SoC 200 also includes a memory 260 that may provide memory controller functionality for interfacing with a system memory such as DRAM. Understand while shown at this high level in the embodiment of FIG. 2, many variations and alternatives are possible. Note that in this implementation, separate power controller circuitry such as power controller 135 and hardware control circuit 140 of FIG. 1 is not separately shown. Depending upon implementation such components may be separate circuits present within SoC 200 or this functionality may be performed by one or more of first and/or second cores or other processing unit.

With embodiments herein, SoC 200 may be configured to maintain, e.g., based on one or more environmental conditions such as power or thermal events, updated hardware feedback information regarding first cores 210 and second cores 215. In turn, control circuitry may, via an interface, inform root and virtual environments regarding this hardware feedback information, which may be used by appropriate schedulers, along with QoS information to schedule threads of given workloads to appropriate core types.

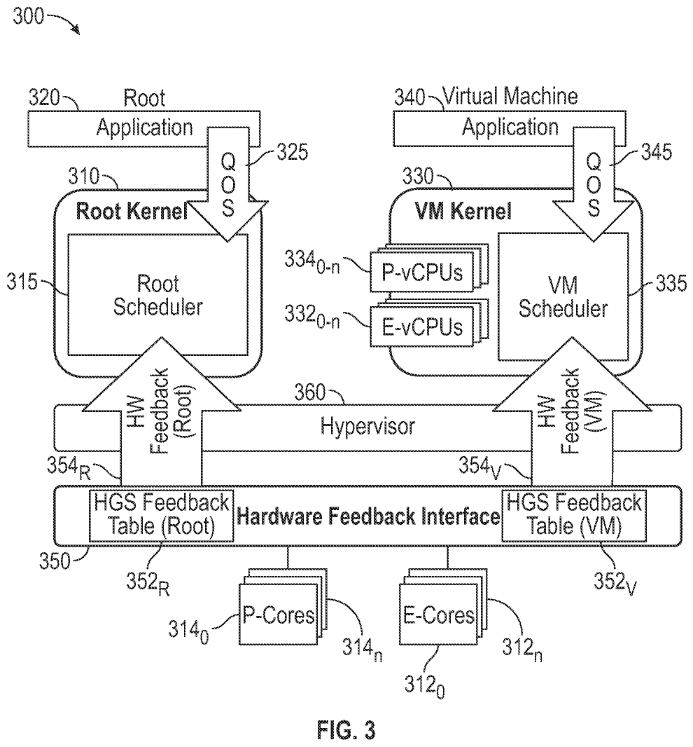

Referring now to FIG. 3, shown is a block diagram illustrating a virtual environment in accordance with an embodiment. In FIG. 3, virtual environment 300 is illustrated at a high level to show interaction between a root and a virtual machine. In virtual environment 300, a root kernel 310 and a VM kernel 330 are present. Although only two kernels are shown, understand that in a particular virtual environment there may be more than one VM kernel. Equally understand that in some cases such as in a cloud-based server implementation, there may not be a root kernel.

In any event, as illustrated in FIG. 3, root kernel 310 includes a root scheduler 315. In various embodiments, root scheduler 315 may be an OS scheduler that is configured to schedule threads of a given application for execution on underlying hardware of a processor, e.g., particular cores, of heterogeneous types. Root scheduler 315 may receive QoS information 325 from root application 320 and schedule individual threads based at least in part on the QoS information. For example, root application 320 may identify within QoS information 325 priority associated with given threads (e.g., of a low, medium, or high priority, although more or fewer delineations are possible).

In turn, root scheduler 315 may schedule such threads based on this QoS information. Root scheduler 315 further bases its scheduling decisions on hardware feedback information 354R. As illustrated, this hardware feedback information may be received from a hardware feedback interface (HFI) 350. In one embodiment, HFI 350 may be implemented as an Intel® Thread Director hardware resource, which maintains and provides hardware feedback information, e.g., in the form of performance and/or efficiency information of the various cores of the processor.

As shown, hardware feedback information 354_{R} may be obtained from a hardware guided scheduling (HGS) feedback table 352_{R}, which is maintained for association with the root. To this end, table 352_{R} may include a plurality of entries each to store, at least, efficiency and performance information for corresponding cores of the processor such as P-cores 314_{0-N} and E-cores 312_{0-N}. In this way, root scheduler 315 receives updated information regarding the energy and performance capabilities of cores and makes appropriate scheduling decisions based at least in part thereon.

Further with embodiments herein, a VM scheduler 335 also may make scheduling decisions based at least in part on hardware feedback information regarding the cores of the processor. To this end, HFI 350 may further include a corresponding virtual hardware feedback table 352_{V}, which is maintained for association with the virtual machine environment. In this way, HFI 350 may, via a hypervisor 360, provide hardware feedback information on a per VM basis to any underlying VM components such as VM kernel 330.

As illustrated, hardware feedback information 354_{V} from hardware feedback table 352v is provided to VM scheduler 335. Based at least in part on this information, along with QoS information 345 provided from a VM application 340, VM scheduler 335 may schedule individual threads to virtual processors of a particular type.

Thus as illustrated, VM scheduler 335 may schedule certain threads to P-virtual CPUs (vCPUs) 334_{0-N} while in turn other threads can be scheduled to E-virtual CPUs 332_{0-N}. In this regard assume that higher priority threads (as determined based at least in part on QoS information 345) may be allocated to P-vCPUs 334, while in turn, lower priority threads (as determined based at least in part on QoS information 345) may be allocated to E-vCPUs 332. Although shown at this high level in the embodiment of FIG. 3, many variations and alternatives are possible.

Thus FIG. 3 shows an implementation in which a virtual machine scheduler receives Intel® Thread Director feedback from its own HGS feedback table. As a result, the virtual machine is not forced to view its vCPUs as a homogenous set but can instead view them as a set of “performant vCPUs” and “efficient vCPUs”, which is more like the actual underlying physical topology. With this arrangement, a closed feedback loop is realized, which enables a virtual machine to schedule threads in a manner more similar to how the root partition would schedule vCPUs. As a result, the root does not have to make as many (or any) corrections to vCPU-to-physical CPU mappings, since most optimal scheduling decisions were made in the first place by the virtual machine. This in turn means that the number of context switches that were previously required to fix initially incorrect vCPU to CPU mappings is reduced or avoided entirely. In situations where there may be multiple virtual machines present, each virtual machine is provided its own associated HGS feedback table. In one or more embodiments, this per virtual machine HGS feedback table may have an entry for a particular core refreshed when that particular core is scheduled to run one of the virtual machine's vCPUs.

In contrast without an embodiment, a virtual machine scheduler does not receive any hardware feedback information and schedules threads to a homogenous set of virtual CPUs. Because of this, the virtual machine scheduler experiences an open feedback loop, as it recognizes thread QoS, but does not have available to it information to make intelligent scheduling decisions. As such without an embodiment, the virtual machine scheduler can schedule threads of important QoS followed by threads of unimportant QoS on any given vCPU, in turn resulting in threads of important QoS being scheduled to non-performant cores and threads of unimportant QoS being scheduled to performant cores. This in turn causes the root partition to have to reshuffle virtual processor-to-physical processor mappings, raising complexity and inefficiency.

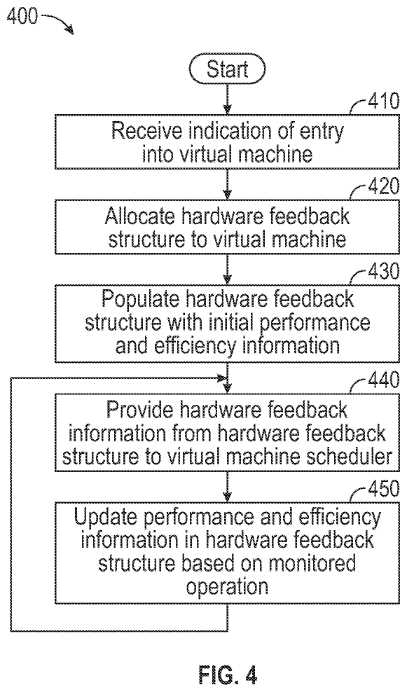

Referring now to FIG. 4, shown is a flow diagram of a method in accordance with an embodiment. As illustrated in FIG. 4, method 400 is a method for providing hardware feedback information directly to a virtual machine in accordance with an embodiment. In one or more embodiments, method 400 may be performed by hardware circuitry in connection with monitoring circuitry that provides hardware monitoring information, alone and/or in combination with firmware and/or software.

As illustrated, method 400 begins by receiving an indication of entry into a virtual machine (block 410). Such indication may be received in a control circuit in response to initiation of a given virtual machine in a processor. Next a hardware feedback structure may be allocated for the virtual machine (block 420). Depending upon implementation, this allocation may be by virtualization of a single hardware feedback structure, e.g., as stored in a shared memory (e.g., a system memory such as a DRAM). In another implementation a replicated hardware feedback structure can be allocated within the shared memory, where this replicated hardware feedback structure is dedicated to the newly instantiated virtual machine.

In any event, control passes next to block 430 where the hardware feedback structure may be populated with initial performance and efficiency information. This information, e.g., in the form of performance and efficiency values for each core within the processor, can be populated into the hardware feedback structure. Next the hardware feedback information is provided to the virtual machine scheduler (block 440).

In this way, the VM scheduler becomes aware of the heterogenous capabilities of the various cores present in the processor. As such, the VM scheduler may make better, more informed scheduling decisions to appropriately allocate given workloads (e.g., threads) to appropriate cores. For example, high priority threads can be allocated to higher performing cores (depending upon the current processor operating environment, e.g., considering power, thermal and other possible constraints), while lower priority threads can be allocated to more efficient cores (again depending upon the current processor operating environment).

Finally with reference to FIG. 4, as operation proceeds, the performance and efficiency information present in the hardware feedback structure may be updated based on monitored operation (block 450). For example, depending upon operating conditions, including temperature, operating frequency, power consumption and so forth, these performance and efficiency values may be updated. As one example, in a more constrained processor environment (e.g., due to thermal or power constraints), the efficient cores may become more performant than the higher performance cores and vice versa. A feedback loop is thus closed as this updated hardware feedback information is provided to the VM scheduler (at block 440). Understand while shown at this high level in the embodiment of FIG. 4, many variations and alternatives are possible.

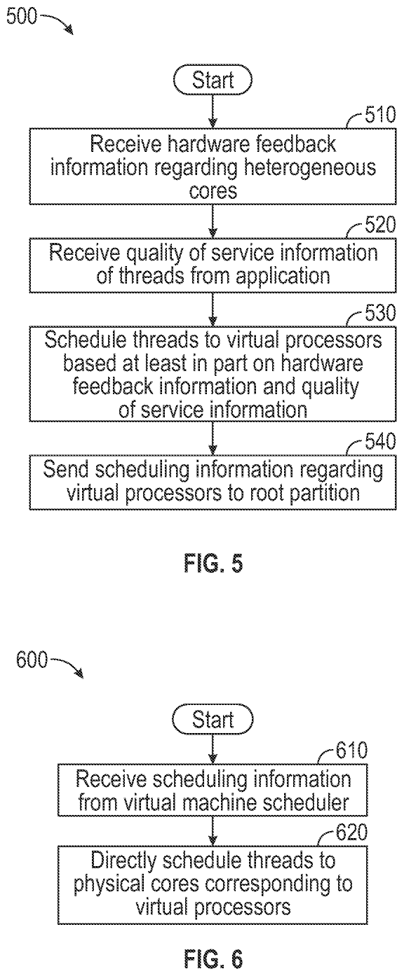

Referring now to FIG. 5, shown is a flow diagram of a method in accordance with another embodiment. In FIG. 5, method 500 is a method for scheduling virtual machine threads in accordance with an embodiment. In one or more embodiments, method 500 may be performed by hardware circuitry such as one or more cores including scheduler circuitry that provides scheduling services for a VM scheduler, alone and/or in combination with firmware and/or software.

Method 500 begins by receiving hardware feedback information regarding the heterogenous cores (block 510). As discussed above, the VM scheduler may receive this information from a hardware feedback interface. Thereafter, control passes to block 520 where the VM scheduler receives QoS information regarding the threads of a given VM application. Note that the ordering shown in FIG. 5 is for purposes of discussion, and receipt of hardware feedback information and QoS information may occur in a different order and/or at different time instances.

In any event, control passes next to block 530 where threads may be scheduled to virtual processors based at least in part on hardware feedback information and the QoS information. In this way, the VM scheduler that is aware of the heterogenous and dynamic capabilities of the cores may make appropriate scheduling decisions, such as to schedule high priority threads on the most performant cores. At block 540, the VM scheduler may send scheduling information regarding the virtual processors to a root partition, and more specifically to a root scheduler of the root partition. Note that this scheduling information may be in the form of identification of a given thread and a particular vCPU and vCPU type to which that thread is to be assigned. Although shown at this high level in the embodiment of FIG. 5, many variations and alternatives are possible.

Referring now to FIG. 6, shown is a flow diagram of a method in accordance with yet another embodiment. In FIG. 6, method 600 is a method for scheduling performed in a root partition in accordance with an embodiment. In one or more embodiments, method 600 may be performed by hardware circuitry such as one or more cores including scheduler circuitry that provides scheduling services for a root scheduler, alone and/or in combination with firmware and/or software.

Method 600 begins by receiving scheduling information from a VM scheduler (block 610). As discussed above, this scheduling information includes an identification of threads and corresponding vCPUs of a given vCPU type to which the threads are to be allocated. Next at block 620, the root scheduler may directly schedule the threads to physical cores that correspond to the virtual processors. That is, by way of this direct scheduling, the root scheduler does not need to migrate workloads between different cores. Nor does it need to re-assign VM threads from one core type to another core type. This is so since the received scheduling information already includes an identification of appropriate core type for a given thread priority. Although shown at this high level in the embodiment of FIG. 6, many variations and alternatives are possible.

Benchmark data was collected of an implementation running on a Windows™ operating system. In one example scenario, benchmarks (important QoS threads) were run alongside a compression/decompression benchmark, which was minimized (unimportant QoS threads), inside a virtual machine.

Two web browser benchmarks, Speedometer2 and WebXPRT, show around a 7% increase in score, while an application benchmark Cinebench20 shows around a 17% increase in score for its multi-threaded version. As such, embodiments, may improve performance by reducing a number of reschedulings by a root scheduler.

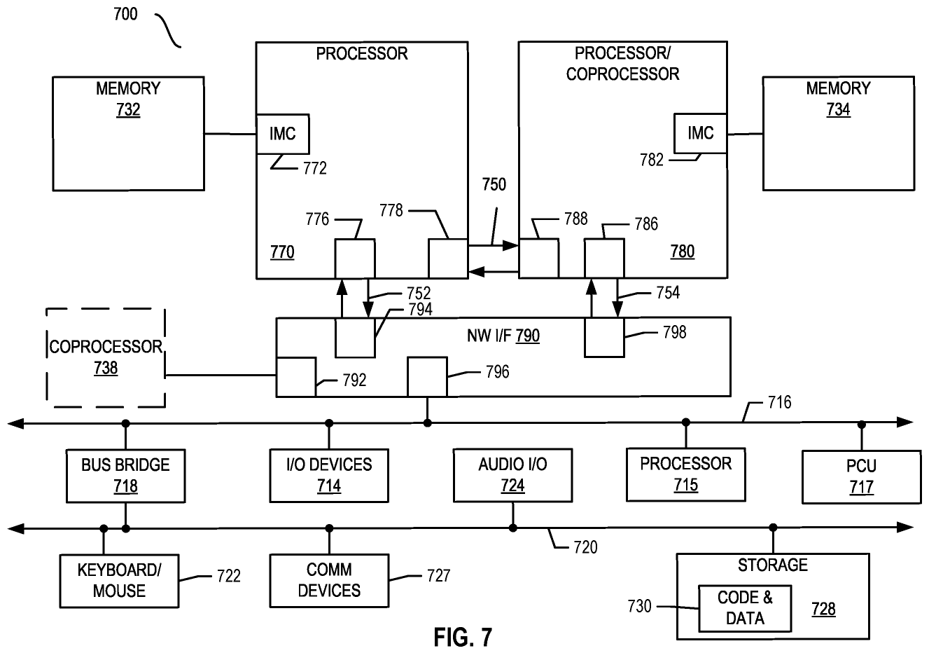

FIG. 7 illustrates an example computing system. Multiprocessor system 700 is an interfaced system and includes a plurality of processors or cores including a first processor 770 and a second processor 780 coupled via an interface 750 such as a point-to-point (P-P) interconnect, a fabric, and/or bus. In some examples, the first processor 770 and the second processor 780 are homogeneous. In some examples, first processor 770 and the second processor 780 are heterogenous. Though the example system 700 is shown to have two processors, the system may have three or more processors, or may be a single processor system. In some examples, the computing system is a SoC.

Processors 770 and 780 are shown including integrated memory controller (IMC) circuitry 772 and 782, respectively. Processor 770 also includes interface circuits 776 and 778; similarly, second processor 780 includes interface circuits 786 and 788. Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors. Processors 770, 780 also may provide a hardware interface to maintain and communicate virtualized hardware scheduling as described herein.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a coprocessor 738 via an interface circuit 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interface 716, along with a bus bridge 718 which couples first interface 716 to a second interface 720. In some examples, one or more additional processor(s) 715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730. Further, an audio I/O 724 may be coupled to second interface 720. Note that other architectures than the point-to-point architecture described above are possible. For example, instead of the point-to-point architecture, a system such as multiprocessor system 700 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

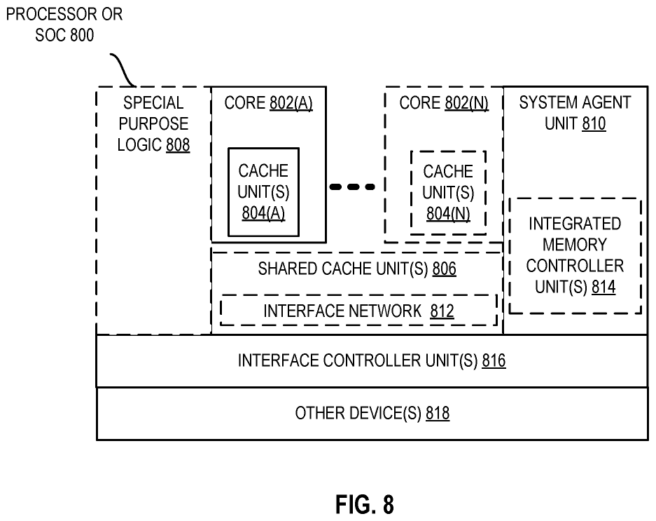

FIG. 8 illustrates a block diagram of an example processor and/or SoC 800 that may have one or more cores and an integrated memory controller. The solid lined boxes illustrate a processor 800 with a single core 802(A), system agent unit circuitry 810, and a set of one or more interface controller unit(s) circuitry 816, while the optional addition of the dashed lined boxes illustrates an alternative processor 800 with multiple cores 802(A)-(N), a set of one or more integrated memory controller unit(s) circuitry 814 in the system agent unit circuitry 810, and special purpose logic 808, as well as a set of one or more interface controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802(A)-(N) being one or more general purpose cores (e.g., general purpose in-order cores, general purpose out-of-order cores, or a combination of the two); 2) a coprocessor with the cores 802(A)-(N) being a large number of special purpose cores intended primarily for graphics and/or scientific (throughput); and 3) a coprocessor with the cores 802(A)-(N) being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller units circuitry 816 couple the cores 802 to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

### Example Core Architectures—In-Order and Out-of-Order Core Block Diagram

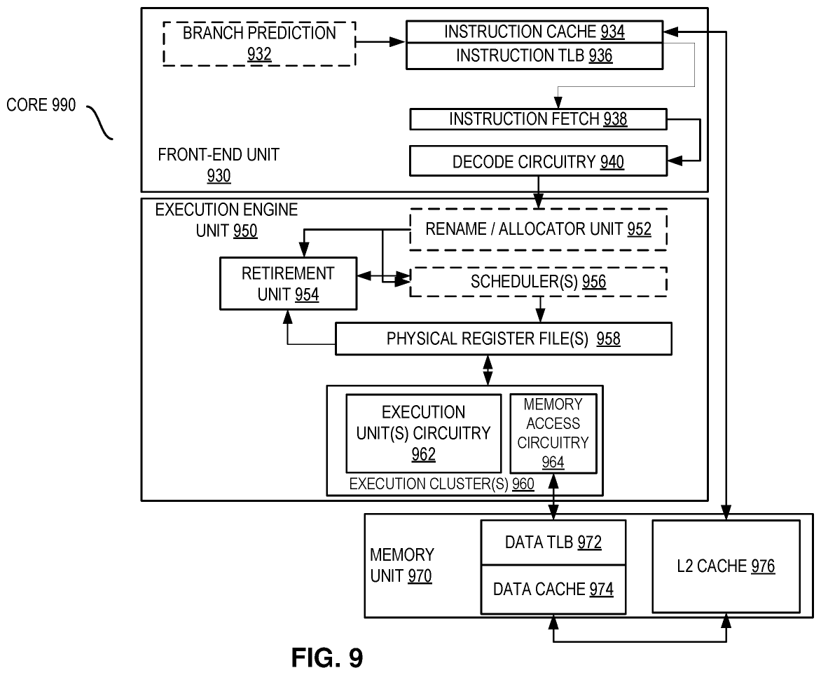

By way of example, the example register renaming, out-of-order issue/execution architecture core of FIG. 9 may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9 shows a processor core 990 including front-end unit circuitry 930 coupled to execution engine unit circuitry 950, and both are coupled to memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front-end unit circuitry 930 may include branch prediction circuitry 932 coupled to instruction cache circuitry 934, which is coupled to an instruction translation lookaside buffer (TLB) 936, which is coupled to instruction fetch circuitry 938, which is coupled to decode circuitry 940. In one example, the instruction cache circuitry 934 is included in the memory unit circuitry 970 rather than the front-end circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include address generation unit (AGU, not shown) circuitry. In one example, the AGU generates an LSU address using forwarded register ports, and may further perform branch forwarding (e.g., immediate offset branch forwarding, LCR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In one example, the core 990 includes a microcode ROM (not shown) or other medium that stores microcode for certain macroinstructions (e.g., in decode circuitry 940 or otherwise within the front-end circuitry 930). In one example, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine circuitry 950.

The execution engine circuitry 950 includes the rename/allocator unit circuitry 952 coupled to retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, address generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to data cache circuitry 974 coupled to level 2 (L2) cache circuitry 976. In one example, the memory access circuitry 964 may include load unit circuitry, store address unit circuitry, and store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In one example, the instruction cache 934 and the data cache 974 are combined into a single instruction and data cache (not shown) in L2 cache circuitry 976, level 3 (L3) cache circuitry (not shown), and/or main memory. The L2 cache circuitry 976 is coupled to one or more other levels of cache and eventually to a main memory.

The core 990 may support one or more instructions sets (e.g., the x86 instruction set architecture (optionally with some extensions that have been added with newer versions); the MIPS instruction set architecture; the ARM instruction set architecture (optionally with optional additional extensions such as NEON)). In one example, the core 990 includes logic to support a packed data instruction set architecture extension (e.g., AVX1, AVX2), thereby allowing the operations used by many multimedia applications to be performed using packed data.

The following examples pertain to further embodiments.

In one example, a processor comprises: a plurality of cores to execute instructions; at least one monitor circuit coupled to the plurality of cores to measure power information and temperature information; and a hardware feedback circuit coupled to the at least one monitor circuit, the hardware feedback circuit to: determine hardware feedback information comprising an energy efficiency capability and a performance capability of at least some of the plurality of cores based at least in part on the power information and the temperature information; and inform a root partition and a virtual partition regarding the energy efficiency capability and the performance capability of the at least some of the plurality of cores.

In an example, the hardware feedback circuit is to allocate at least one hardware feedback data structure to store the hardware feedback information.

In an example, the hardware feedback circuit is to allocate: a first hardware feedback data structure to store the hardware feedback information, the first hardware feedback data structure accessible to the root partition; and a second hardware feedback data structure to store the hardware feedback information, the second hardware feedback data structure accessible to the virtual partition.

In an example, the hardware feedback circuit is to allocate the at least one hardware feedback data structure in a shared memory, the shared memory accessible to the root partition and the virtual partition.

In an example, the shared memory is to store a first table having at least some of the hardware feedback information and a second table having at least some of the hardware feedback information, the first table accessible to the root partition and the second table accessible to the virtual partition.

In an example, the plurality of cores comprises at least one first core and at least one second core, the at least one second core heterogenous to the at least one first core.

In an example, the processor is to enable a root scheduler of the root partition and a virtual machine scheduler of the virtual partition to access the hardware feedback data structure.

In an example, the virtual machine scheduler is to schedule a first thread to a first virtual processor based at least in part on quality of service information for the first thread and at least some of the hardware feedback information, the first virtual processor associated with the at least one first core.

In an example, the root scheduler is to: receive first schedule information from the virtual machine scheduler, the first schedule information to identify the first thread and the first virtual processor; and receive second schedule information from the virtual machine scheduler, the second schedule information to identify a second thread and a second virtual processor, the second virtual processor associated with the at least one second core.

In an example, the root scheduler is to directly schedule the first thread to the at least one first core and the second thread to the at least one second core.

In an example, the virtual machine scheduler is to schedule the first thread to the first virtual processor when the quality of service information for the first thread exceeds a threshold level and the at least one first core comprises a performance core.

In another example, a method comprises: receiving, in a first circuit of a processor, an indication of an entry of the processor into a first virtual machine, the processor to execute in a virtual machine environment having a root partition and at least one virtual partition comprising the first virtual machine; allocating a first hardware feedback structure for the root partition and allocating a second hardware feedback structure for the at least one virtual partition; populating the first hardware feedback structure with first performance and efficiency information regarding a plurality of cores of the processor; populating the second hardware feedback structure with the first performance and efficiency information regarding the plurality of cores of the processor; and providing the first performance and efficiency information from the second hardware feedback structure to a virtual machine scheduler of the at least one virtual partition.

In an example, the method further comprises updating the first performance and efficiency information, based at least in part on monitored information regarding operation of the processor.

In an example, the method further comprises exposing heterogeneity of at least one first core of the plurality of cores and at least one second core of the plurality of cores to the virtual machine scheduler via the second hardware feedback structure.

In an example, the method further comprises: populating the first hardware feedback structure and the second hardware feedback structure with the first performance and efficiency information comprising initial performance and efficiency information regarding the plurality of cores; and updating the first performance and efficiency information of the second hardware feedback structure independently of the first performance and efficiency information of the first hardware feedback structure.

In an example, populating the second hardware feedback structure with the first performance and efficiency information comprises storing in the second hardware feedback structure a first efficiency value and a first performance value for at least one first core of the plurality of cores and a second efficiency value and a second performance value for at least one second core of the plurality of cores.

In an example, the method further comprises allocating the first hardware feedback structure and the second hardware feedback structure in a shared memory coupled to the processor.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system comprises: a SoC and a system memory coupled to the SoC, the system memory to store a hardware feedback structure. The SoC may include: a first plurality of cores to execute instructions; a second plurality of cores to execute instructions, the second plurality of cores heterogenous to the first plurality of cores; a power controller to control delivery of an operating voltage and an operating frequency to the first plurality of cores and the second plurality of cores; and a control circuit coupled to the first plurality of cores and the second plurality of cores, the control circuit comprising a closed loop to provide hardware feedback information regarding the first plurality of cores and the second plurality of cores, the control circuit to allocate at least one hardware feedback structure to store the hardware feedback information, the at least one hardware feedback structure accessible to a root partition and a virtual partition.

In an example, the SoC is to communicate at least some of the hardware feedback information to a virtual machine scheduler of the virtual partition and a scheduler of the root partition.

In an example, the virtual machine scheduler is to schedule a first thread to a first virtual processor associated with the first plurality of cores and schedule a second thread to a second virtual processor associated with the second plurality of cores, and the scheduler of the root partition is to receive scheduling information from the virtual machine scheduler and, based at least in part thereon, to schedule the first thread to a first core of the first plurality of cores and schedule the second thread to a second core of the second plurality of cores.

In a still further example, an apparatus comprises: means for receiving an indication of an entry of a processor into a first virtual machine, the processor to execute in a virtual machine environment having a root partition and at least one virtual partition comprising the first virtual machine; means for allocating a first hardware feedback means for the root partition and means for allocating a second hardware feedback means for the at least one virtual partition; means for populating the first hardware feedback means with first performance and efficiency information regarding a plurality of cores of the processor; means for populating the second hardware feedback means with the first performance and efficiency information regarding the plurality of cores of the processor; and means for providing the first performance and efficiency information from the second hardware feedback means to a virtual machine scheduling means of the at least one virtual partition.

In an example, the apparatus further comprises means for updating the first performance and efficiency information, based at least in part on monitored information regarding operation of the processor.

In an example, the apparatus further comprises means for exposing heterogeneity of at least one first core of the plurality of cores and at least one second core of the plurality of cores to the virtual machine scheduling means via the second hardware feedback means.

In an example, the apparatus further comprises: means for populating the first hardware feedback means and the second hardware feedback means with the first performance and efficiency information comprising initial performance and efficiency information regarding the plurality of cores; and means for updating the first performance and efficiency information of the second hardware feedback means independently of the first performance and efficiency information of the first hardware feedback means.

In an example, the apparatus further comprises shared memory means for storing the first hardware feedback means and the second hardware feedback means.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SOC or other processor, is to configure the SOC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A processor comprising:
a plurality of cores to execute instructions;
at least one monitor circuit coupled to the plurality of cores to measure power information and temperature information; and
a hardware feedback circuit coupled to the at least one monitor circuit, the hardware feedback circuit to:
determine hardware feedback information comprising an energy efficiency capability and a performance capability of at least some of the plurality of cores based at least in part on the power information and the temperature information; and
inform a root partition and a virtual partition regarding the energy efficiency capability and the performance capability of the at least some of the plurality of cores.

2. The processor of claim 1, wherein the hardware feedback circuit is to allocate at least one hardware feedback data structure to store the hardware feedback information.

3. The processor of claim 2, wherein the hardware feedback circuit is to allocate:
a first hardware feedback data structure to store the hardware feedback information, the first hardware feedback data structure accessible to the root partition; and
a second hardware feedback data structure to store the hardware feedback information, the second hardware feedback data structure accessible to the virtual partition.

4. The processor of claim 2, wherein the hardware feedback circuit is to allocate the at least one hardware feedback data structure in a shared memory, the shared memory accessible to the root partition and the virtual partition.

5. The processor of claim 4, wherein the shared memory is to store a first table having at least some of the hardware feedback information and a second table having at least some of the hardware feedback information, the first table accessible to the root partition and the second table accessible to the virtual partition.

6. The processor of claim 2, wherein the plurality of cores comprises at least one first core and at least one second core, the at least one second core heterogenous to the at least one first core.

7. The processor of claim 6, wherein the processor is to enable a root scheduler of the root partition and a virtual machine scheduler of the virtual partition to access the hardware feedback data structure.

8. The processor of claim 7, wherein the virtual machine scheduler is to schedule a first thread to a first virtual processor based at least in part on quality of service information for the first thread and at least some of the hardware feedback information, the first virtual processor associated with the at least one first core.

9. The processor of claim 8, wherein the root scheduler is to:
receive first schedule information from the virtual machine scheduler, the first schedule information to identify the first thread and the first virtual processor; and
receive second schedule information from the virtual machine scheduler, the second schedule information to identify a second thread and a second virtual processor, the second virtual processor associated with the at least one second core.

10. The processor of claim 9, wherein the root scheduler is to directly schedule the first thread to the at least one first core and the second thread to the at least one second core.

11. The processor of claim 8, wherein the virtual machine scheduler is to schedule the first thread to the first virtual processor when the quality of service information for the first thread exceeds a threshold level and the at least one first core comprises a performance core.

12. At least one computer readable medium comprising instructions, which when executed by a processor, cause the processor to execute a method comprising:
receiving, in a first circuit of a processor, an indication of an entry of the processor into a first virtual machine, the processor to execute in a virtual machine environment having a root partition and at least one virtual partition comprising the first virtual machine;
allocating a first hardware feedback structure for the root partition and allocating a second hardware feedback structure for the at least one virtual partition;
populating the first hardware feedback structure with first performance and efficiency information regarding a plurality of cores of the processor;
populating the second hardware feedback structure with the first performance and efficiency information regarding the plurality of cores of the processor; and
providing the first performance and efficiency information from the second hardware feedback structure to a virtual machine scheduler of the at least one virtual partition.

13. The at least one computer readable medium of claim 12, wherein the method further comprises updating the first performance and efficiency information, based at least in part on monitored information regarding operation of the processor.

14. The at least one computer readable medium of claim 12, wherein the method further comprises exposing heterogeneity of at least one first core of the plurality of cores and at least one second core of the plurality of cores to the virtual machine scheduler via the second hardware feedback structure.

15. The at least one computer readable medium of claim 14, wherein the method further comprises:
populating the first hardware feedback structure and the second hardware feedback structure with the first performance and efficiency information comprising initial performance and efficiency information regarding the plurality of cores; and
updating the first performance and efficiency information of the second hardware feedback structure independently of the first performance and efficiency information of the first hardware feedback structure.

16. The at least one computer readable medium of claim 12, wherein populating the second hardware feedback structure with the first performance and efficiency information comprises storing in the second hardware feedback structure a first efficiency value and a first performance value for at least one first core of the plurality of cores and a second efficiency value and a second performance value for at least one second core of the plurality of cores.

17. The at least one computer readable medium of claim 12, wherein the method further comprises allocating the first hardware feedback structure and the second hardware feedback structure in a shared memory coupled to the processor.

18. A system comprising:
a system on chip (SoC) comprising:
a first plurality of cores to execute instructions;
a second plurality of cores to execute instructions, the second plurality of cores heterogenous to the first plurality of cores;
a power controller to control delivery of an operating voltage and an operating frequency to the first plurality of cores and the second plurality of cores; and
a control circuit coupled to the first plurality of cores and the second plurality of cores, the control circuit comprising a closed loop to provide hardware feedback information regarding the first plurality of cores and the second plurality of cores, the control circuit to allocate at least one hardware feedback structure to store the hardware feedback information, the at least one hardware feedback structure accessible to a root partition and a virtual partition; and
a system memory coupled to the SoC, the system memory to store the hardware feedback structure.

19. The system of claim 18, wherein the SoC is to communicate at least some of the hardware feedback information to a virtual machine scheduler of the virtual partition and a scheduler of the root partition.

20. The system of claim 19, wherein the virtual machine scheduler is to schedule a first thread to a first virtual processor associated with the first plurality of cores and schedule a second thread to a second virtual processor associated with the second plurality of cores, and the scheduler of the root partition is to receive scheduling information from the virtual machine scheduler and, based at least in part thereon, to schedule the first thread to a first core of the first plurality of cores and schedule the second thread to a second core of the second plurality of cores.
